(19) United States
(12) Patent Application Publication
(10) Pub. No.: US 2001/0050608 A1
(43) Pub. Date: Dec. 13, 2001

(54) Multiple terminal/branch circuit fuse

(76) Inventors: Tery J. Evans, Buford, GA (US); Ruel Emmet Davis, St. Peters, MO (US); Matthew Alan Joiner, Fenton, MO (US)

Correspondence Address: John S. Beulick, Esq., Armstrong Teasdale LLP, Suite 2600, One Metropolitan Sq., St. Louis, MO, 63102, US

(21) Appl. No.: 09/821,933

(22) Filed: Mar. 30, 2001

Related U.S. Application Data
(63) Continuation-in-part of application No. 09/184,647, filed on Nov. 3, 1998, now abandoned.
(60) Provisional application No. 60/073,753, filed on Feb. 5, 1998.

(51) Int. Cl. H01H 85/04

(52) U.S. Cl. 337/293

(57) ABSTRACT

A fuse for providing a connection between a multiple-source power supply having a plurality of cells and a power receiving device, includes a plurality of separate terminal leads, a common connector region, and a plurality of fuse links fabricated from a first conductive material and interconnecting a respective one of the terminal leads to the common connector region. At least a portion of at least one of the fuse links includes an overlay of a second conductive material that is different from the first conductive material from which the fuse link is fabricated. The second conductive material of the overlay has a lower melting temperature than does the first conductive material of the fuse link to lower the operating temperature of the fuse link.

### CROSS REFERENCE TO RELATED APPLICATIONS

This application is a continuation-in-part application of U.S. patent application Ser. No. 09/184,647, filed Mar. 28, 2000, which is a continuation prosecution application of U.S. patent application Ser. No. 09/184,647, filed Nov. 3, 1998, which claims the benefit of U.S. Provisional patent application Ser. No. 60/073,753 filed Feb. 5, 1998.

### BACKGROUND OF THE INVENTION

The invention relates to fuses generally. In particular, it relates to a fuse arrangement that provides a fuse-link connection for multiple power sources to a single common electrical connector attachment region.

Drawing power from a multiple-source power supply, such as a battery pack having a plurality of cells, often presents problems. While it is desirable to “cut off” malfunctioning individual cells or sources though a fuse link before the device receiving power is damaged, it is also desirable to be able to continue to supply power to the device. Use of a plurality of individual fuses for this purpose would waste valuable space and render assembly more difficult and time consuming.

U.S. Pat. No. 3,877,770 to Sanders et. al. discloses an electrical connector that connects the ends of two separate segments of a multiple conductor ribbon-type cable. The connector includes a plurality of conductive strips each including a fuse link. Each individual conductive strip of the connector is used to contact one individual conductor of the ribbon-type cable to an individual conductor of another ribbon-type cable.

U.S. Pat. No. 4,670,725 to Ahs discloses a relay tongue unit having a main portion, 20 fuse portion, transition portions and tongue portions. The relay tongue unit is disclosed as being attached to a relay by a clamp which is screwed into the relay. Ahs discloses that if a single fuse blows the entire unit is to be replaced.

U.S. Pat. No. 2,934,627 to Bristol et. al. discloses a plate-like element having a printed circuit pattern. The printed circuit pattern includes a common lead or conductor, fuse portions, and a plurality of individual leads. Bristol et. al. discloses inserting the device into a slot of a receptacle in order to centralize all fuse elements in a single location.

U.S. Pat. Nos. 3,810,063 and 3,721,935 to Blewitt and Kozacka, respectively, each disclose a plurality of fuse links that interconnect two singular blade type connections at both ends of the fuse.

### BRIEF SUMMARY OF THE INVENTION

In an exemplary embodiment, a fuse for providing a connection between a multiple-source power supply having a plurality of cells and a power receiving device, includes a plurality of separate terminal leads, a common connector region, and a plurality of fuse links fabricated from a first conductive material and interconnecting a respective one of the terminal leads to the common connector region. At least a portion of at least one of the fuse links includes an overlay of a second conductive material that is different from the first conductive material from which the fuse link is fabricated. The second conductive material of the overlay has a lower melting temperature than does the first conductive material of the fuse link. In one embodiment, the fuse links are fabricated from copper and the overlay is fabricated from tin.

When at least one terminal is connected to the power supply and the common connector region is connected to the power receiving device, current flows from the connected terminal lead, through the associated fuse link, to the common connector region and to the power receiving device. In an overcurrent condition, the overlay melts and forms an alloy with the material of the fuse link having a lower melting temperature than the fuse link material. As such, an operating temperature of the fuse link is controlled, and the fuse link does not reach higher operating temperatures that the fuse link material would otherwise allow. Safety is therefore improved due to lower operating temperatures of the fuse links, and, as desired, operating points of adjacent fuse links may be varied by providing, not providing, or varying the overlay to provide a more versatile fuse. Therefore, malfunctioning power sources may be isolated from the power receiving device while the remaining power sources continue to supply power to the power receiving devices through the remaining terminal leads and fuse links.

Additionally, a protective body is attached to the fuse in at least the area of the fuse links and includes a two piece construction that is intermitted to at least the common connector region. In various embodiments, the fuse links include skived fuse links, wire like members, and narrowed regions formed in the terminal leads.

### BRIEF DESCRIPTION OF THE DRAWINGS

FIG. 1 is top view of a fuse according to the present invention;

FIG. 2 is an end view of the fuse of FIG. 1;

FIG. 3A is a side view of the fuse of FIG. 1;

FIG. 3B is a side view of an alternative embodiment of the fuse of FIG. 1;

FIG. 4 is a top view of the fuse of FIG. 1 in an intermediate stage of manufacture;

FIG. 5 is a cross-sectional view taken along line 5-5 of FIG. 4;

FIG. 6 is a side view of a fuse link structure that can be used with present invention;

FIG. 7 is a top view of another fuse link structure that can be used with the present invention;

FIG. 8 is a side view of the fuse link of FIG. 7;

FIG. 9 is a top view of an alternative fuse link structure that can be used with the present invention;

FIG. 10 is a top view of yet another alternative fuse link structure that can be used with the present invention;

FIG. 11 is a side view of the fuse link of FIG. 10; and

FIG. 12 is a partial top plan view of another embodiment of a fuse.

### DETAILED DESCRIPTION OF THE INVENTION

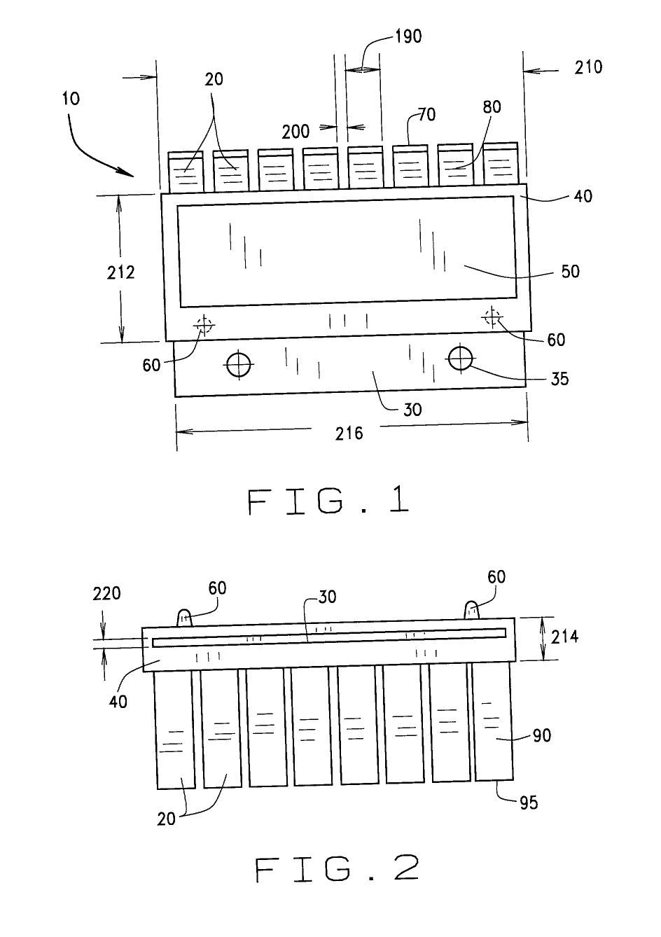

Referring now to FIG. 1, a fuse device of the present invention is shown generally at 10. The fuse 10 includes a plurality of separate individual terminal leads 20 that can be used to provide electrical connection from a plurality of power sources, such as individual cells of a multiple-cell battery (not shown), to a single load, such as a radio or telephone. The fuse of the present invention is also suited for high-current applications such as electric 10 vehicles and off-peak energy storage devices for electric utilities. The terminal leads 20 are preferably constructed of a conductive metal such as copper. However, any other suitable conductive material can be used.

The number of terminal leads can vary according to the particular requirements of a desired application. In the embodiment illustrated in the figures, there are eight individual terminal leads 20. On the opposite side of the fuse 10 is a common contact area 30, which provides a single area for electrical connection to a power receiving device. The common contact area 30 can include apertures 35 for facilitating electrical and/or mechanical connection.

The fuse 10 also includes a protective body 40. The material of the protective body is nonconductive and can be formed from any suitable nonconductive material. Preferably, the protective body 40 is formed of a nonconductive plastic material. At least one protective cover 50 is attached to the protective body 40 and is mounted on a ledge 42 within an opening in the protective body 40 (see FIGS. 1 and 5). The protective body may also include at least two projections 60 for facilitating mounting of the fuse 10. The protective body 40 and at least one cover 50 enclose the fuse links protecting them from the environment, preventing unintended touching of the fuse links, and containing the fuse links when the fuse element is “blown” during an overload condition. The protective plastic housing can be constructed from two separate interfitting pieces 100 and 110.

While the design of the fuse 10 of the present invention can have any appropriate size, as determined by a desired application, the following dimensions are disclosed for illustrative purposes.

| | |
|---|---|
| Width 210 of protective body 40 = | 42.75 mm |
| Depth 212 of protective body 40 = | 16.00 mm |
| Thickness 214 of protective body 40 = | 4.5 mm |
| Width 190 of leads 20 = | 4.0 mm |
| Space 200 between leads 20 = | 1.25 mm |
| Width 216 of common contact area 30 = | 40.0 mm |
| Thickness 220 of terminal leads 20 = | 0.64 mm |

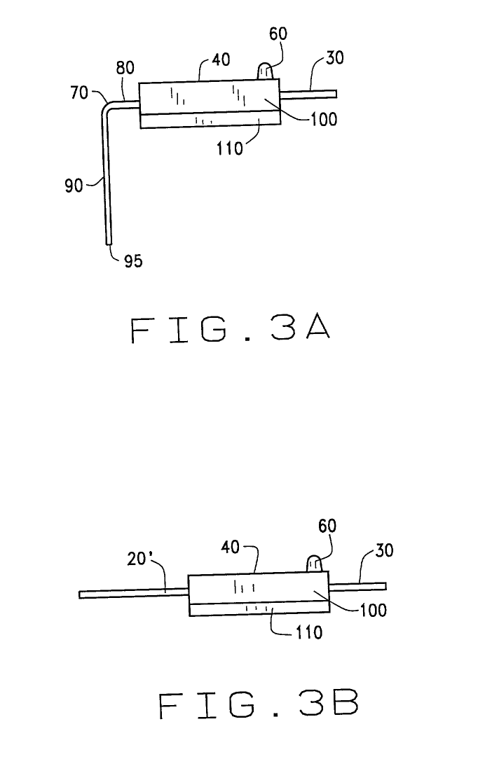

Referring to FIG. 2 and FIG. 3A, the common contact area 30 extends from one side of the protective body 40. The terminal leads 20 can be of any shape required and extend from an opposite side of the protective body 40 along region 80 until bend 70 is reached. Terminal leads then extend from the bend 70 along a distal region 90 and terminate at ends 95. The terminal leads 20 are bent at an angle of approximately 90°. The thickness 220 of the conductive metal sheet that forms the common contact area 30 and the terminal leads 20 is illustrated at 220.

Alternatively, as illustrated in FIG. 3B, terminal leads 20′ can extend straight from protective body 40, without being bent.

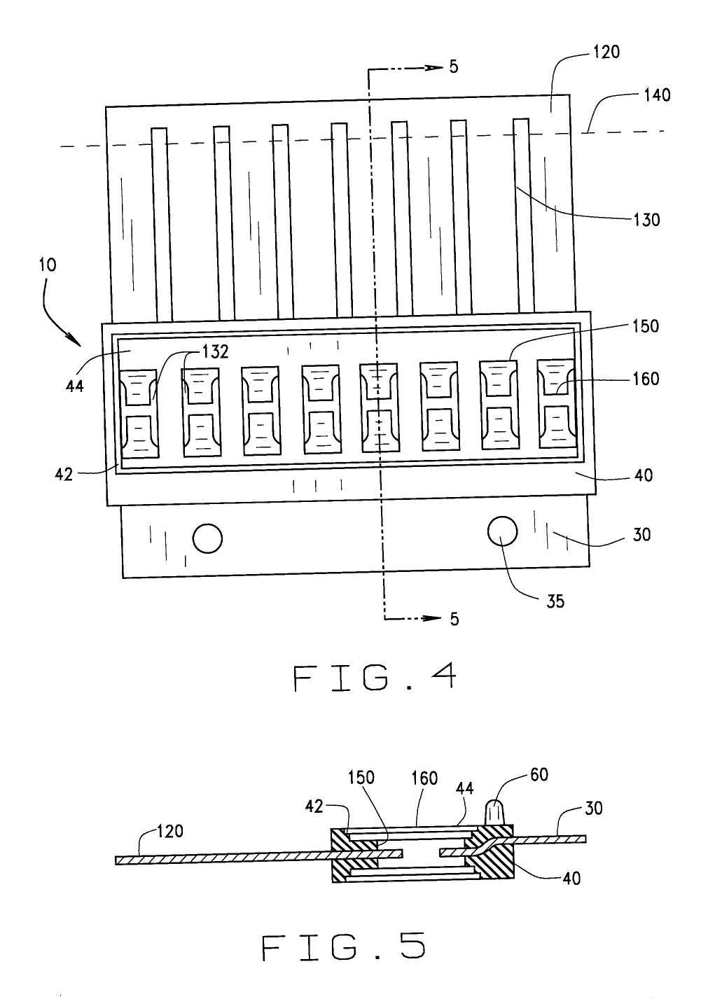

Referring to FIG. 4, the fuse 10 is shown in an intermediate stage of manufacture. While the fuse 10 can be made by any suitable manufacturing process, one such process will be described as follows. A sheet made from a conductive material, such as copper, is stamped so that a conductive terminal lead frame 120 is produced that includes slots 130. The slots 130 are widest at a region 132. The nonconductive protective plastic body 40 is then attached to the lead frame 120 by any suitable method, such as insert molding, or snap-fitting the two separate housing pieces 100, 110 about the lead frame 120. The lead frame 120 is then stamped in the fuse link areas 160 in order to separate the terminal leads 20 from the common contact area 30. The plastic body includes openings 150. The fuse link areas 160 are accessed through openings 150.

Fuse links 170 are mounted to the terminal leads 20 so as to connect them to the common contact area 30. A protective cover 50 may then be attached on each side of the protective body 40 in order enclose the fuse link areas. The covers 50 may be attached by any suitable method, such as adhesive bonding or sonic welding. The lead frame 120 is then severed along line 140 to form the individual terminal leads 20. The terminal leads 20 are then bent at angle 70, if so desired.

FIG. 5 is a cross-sectional view taken along line 5-5 of FIG. 4. FIG. 5 shows the specific construction of openings 150, fuse link area 160, terminal frame 120, plastic body 40, ledge 42, projection 60, and common contact area 30.

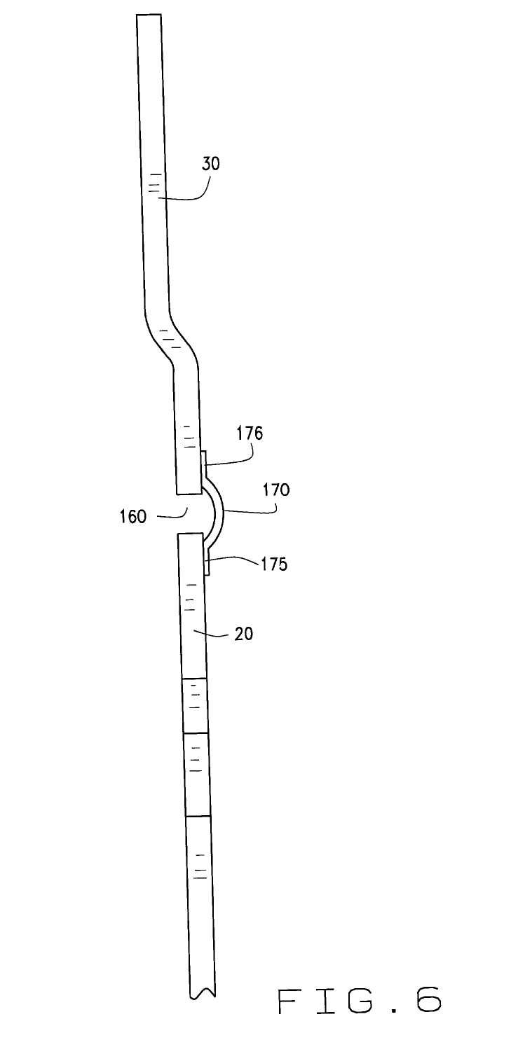

FIG. 6 is a side view of one preferred form of fuse link construction. In this form, the terminal leads 20 are severed from the common contact area 30 by, for example, stamping. One end of a fuse link element such as a wire 170 is attached to the terminal lead 20 at 175 and the other end of the fuse link element is attached to the common contact area 30 at 176. In one embodiment, the wire has a diameter of approximately 0.28 mm. The wire bonding technique is flexible. Different diameter wires and/or wire lengths can be utilized to produce the desired effect. Multiple wires can be attached to a single terminal lead 20 having the same or different dimensions or materials. These techniques can be used to produce different fuse ratings for individual terminals and/or to alter the time/current characteristics. The wire material of the fuse link 170 can be of any suitable material, such as silver, copper, or gold. In the preferred embodiment, the wire material is formed of 0.9999 (99.99%) pure silver. Alternative embodiments may include fuse links of other sizes and materials. The fuse element 10 is attached to the terminal lead 20 and common contact area 30 by any suitable method, such as ultrasonic wedge bonding.

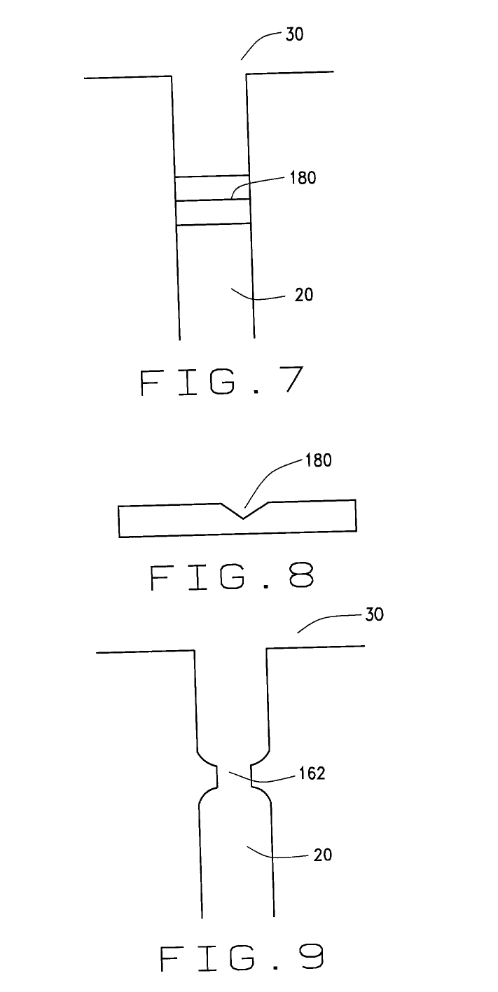

FIG. 7 and FIG. 8 illustrate an alternative fuse link construction of the present invention. Here the thickness of the terminal lead 20 in the fuse link area 160 is of a reduced cross-sectional thickness. This region of reduced cross-sectional thickness at 180 is adapted to “blow” under an overload condition thereby interrupting the electrical connection to that particular source or cell. The reduction in thickness can be achieved by any suitable method, such as forming a notch 180 in at least one surface of the terminal lead.

FIG. 9 illustrates another form of the fuse link construction of the present invention. Here the width of the terminal lead is narrowed or “necked” at 162 in the fuse link area 160. Once again, This region of reduced cross-sectional thickness at 162 is adapted to “blow” under an overload condition thereby interrupting the electrical connection to that particular source or cell.

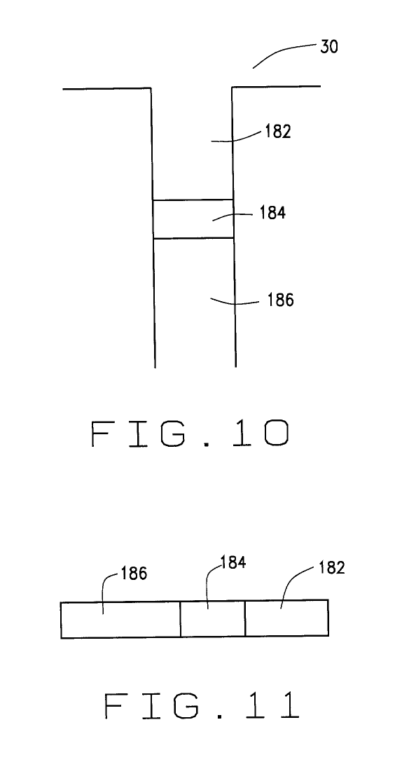

FIG. 10 illustrates yet another possible fuse link construction. In this embodiment a thrulay 184 defines the fuse link and extends between adjacent first and second terminal lead sections 182 and 184. The thrulay 184 and adjacent sections can be formed of any suitable material. For example, adjacent sections 182, 186 can be formed of copper, while thrulay 184 is formed of zinc or silver. It should be noted that the thrulay 184 may be provided with any of the disclosed notches, narrowed regions or other surface modifications disclosed herein.

The fuse link areas can take numerous forms not specifically illustrated. For example, the fuse link area could be defined by a combination of a narrowed or necked region and reduced cross-sectional dimension by forming a notch in the narrowed or necked region. Alternatively, the fuse link area can be formed by a hole in the lead frame 120. The hole could be circular, oval, ovoid, square, rectangular, diamond, wedge-shaped, or any shape required to product the disclosed characteristics.

By utilizing the above mentioned principles it is possible to construct fuses having a rating of 10 A to at least 500 A.

By providing each terminal lead 20 with its own fuse link member leading into a common contact area 30, it is possible to provide a fuse structure, and associated method, by which malfunctioning individual sources, circuits, or cells can be isolated, while properly functioning sources, circuits, or cells can continue to be electrically connected to common contact area 30 via terminal leads 20.

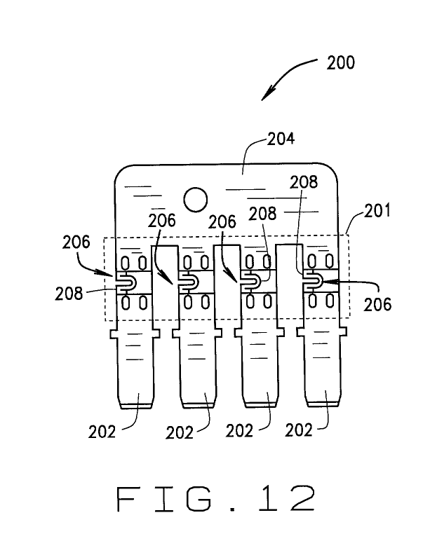

FIG. 12 is a partial top plan view of another embodiment of a fuse 200 with a protective body 201 (shown in phantom in FIG. 12) removed. Protective body 201, in one embodiment, is similar to protective body 40, as described above and illustrated in relation to FIGS. 1-5.

Fuse 200 includes a plurality of separate conductive terminal leads 202, a common contact area or region 204 fabricated from a conductive material, and a plurality of conductive fuse links 206 connecting common contact region 204 to a respective terminal lead 202. An electrical connection from a plurality of power sources, such as individual cells of a multiple-cell battery (not shown), to a single load, such as a radio or telephone, is thus facilitated by electrically coupling the power sources to respective terminal leads 202, and by coupling the load to common connector region 204. As such, current flows from the power sources to terminal leads 202, through fuse links 206, to common connector region 204, and ultimately to the load receiving device. Fuse links 206 protect the load receiving device from a malfunctioning power source when current through the associated fuse link 206 exceeds a predetermined magnitude, thereby melting, disintegrating, or otherwise opening the associated fuse link and breaking an electrical circuit between the malfunctioning power source and the load receiving device through fuse 200, while supplying power to the load receiving device through the remaining terminal leads and fuse links. As noted above, the magnitude of current carried by a fuse link 206 is dependent upon fuse link characteristics, for example, the dimensions of the fuse link and the material from which it is fabricated.

In an exemplary embodiment each fuse link 206 is skived and, to further improve performance, is coated with an overlay 208 of a conductive metal that is different from a composition of fuse link 206. In one embodiment, for example, fuse links 206 are fabricated from copper and overlay 208 is fabricated from tin. As tin has a lower melting temperature than copper, overlay 208 is heated to a melting temperature in an overcurrent condition before copper fuse links 206. The melted overly then reacts with copper fuse links 206 and forms a tin-copper alloy that has a lower melting temperature than either tin or copper by itself. As such, an operating temperature of fuse links 206 is lowered in an overcurrent condition, and fuse links 206 are prevented from reaching the higher melting point of copper. Thus, conductive characteristics and advantages of copper are utilized while avoiding undesirable operating temperatures. In alternative embodiments, other conductive materials may be used to fabricate fuse links 206 and overlay 208, including but not limited to cooper alloys and tin alloys, respectively, to achieve similar benefits. In further alternative embodiments, overlay 208 is fabricated from antimony or indium.

Overlay 208 is applied to fuse links 206 using known techniques, including but not limited to electrolytic plating baths, thin film deposition techniques, and vapor deposition processes. Using these techniques, in various embodiments overlay 208 is applied to some or all of fuse links 206. For example, in one embodiment, only a center portion of a fuse link 206 includes overlay 208, while in another embodiment, an entire area of a fuse link 206 includes overlay 208. In a further embodiment, overlay 208 is applied on one side only of a fuse link 206, while in a different embodiment, both sides of a fuse link 206 include overlay 208.

In further alternative embodiments of fuse 200, less than all fuse links 206 of fuse 200 include overlay 208 to vary a melting temperature or operating point, as desired, between respective fuse links 206. Further, while in the illustrated embodiment four terminal leads 202 and four fuse links 206 are employed in conjunction with common contact region 204, greater or fewer numbers of terminal leads 202 and fuse links 206 may be employed as desired in a given application.

It is contemplated that overlay 208 may be similarly employed in the embodiments described above in relation to FIGS. 1-11 to lower an operating temperature of the respective fuse links in operation.

It is further contemplated that more than one fuse link 206 may be employed to connect common contact region 204 with a respective terminal lead 202, and the fuse links may have the same or different characteristics. In various embodiments of this sort, selected combinations of fuse links with and without overlay 208 may be employed to achieve desired performance objectives. Moreover, different compositions of overlay 208 and/or fuse links 206 may be used to vary operating temperatures of adjacent fuse links 206 in a single fuse 200.

While the invention has been described in terms of various specific embodiments, those skilled in the art will recognize that the invention can be practiced with modification within the spirit and scope of the claims.

What is claimed is:

1. A fuse for providing a connection between a multiple-source power supply having a plurality of cells and a power receiving device, said fuse comprising:
a plurality of separate terminal leads;
a common connector region; and
a plurality of fuse links, each of said fuse links fabricated from a first conductive material and interconnecting a respective one of said terminal leads to said common connector region, at least a portion of at least one of said fuse links comprising an overlay of a second conductive material different from said first conductive material, said second conductive material having a lower melting temperature than said first conductive material.

2. A fuse in accordance with claim 1, wherein said at least one of said fuse links is fabricated from copper.

3. A fuse in accordance with claim 2 wherein said overlay is fabricated from tin.

4. A fuse in accordance with claim 1 wherein said at least one of said fuse links is fabricated from a copper alloy.

5. A fuse in accordance with claim 1 wherein said at least one of said fuse links is fabricated from a tin alloy.

6. A fuse in accordance with claim 1 further comprising a protective body attached to said fuse in at least the area of said fuse links.

7. A fuse in accordance with claim 6, said protective body comprising at least two separate pieces that are intermitted to at least said common connector region.

8. A fuse in accordance with claim 1, wherein at least one of said fuse links is skived.

9. A fuse in accordance with claim 1 wherein at least one fuse link comprises a wire-like member that bridges a gap between a terminal lead and a common connector region.

10. A fuse in accordance with claim 9, wherein said wire-like member has a diameter of approximately 0.28 mm.

11. A fuse in accordance with claim 1, wherein at least one of said fuse links comprises a narrowed region formed in said terminal leads.

12. A fuse for connecting a multiple-source power supply having a plurality of cells to a power receiving device, said fuse comprising:
a plurality of separate terminal leads;
a common connector region;
a plurality of fuse links fabricated from a first conductive material, each of said fuse links interconnecting a respective one of said terminal leads to said common connector region thereby connecting said multiple-source power supply with said power receiving device, at least a portion of at least one of said fuse links comprising an overlay of a second conductive material, a melting temperature of said second conductive material less than a melting temperature of said first conductive material; and
current flowing from at least one of said plurality of terminal leads, through at least one of said fuse links, and to said common connector region when said at least one terminal is connected to the power supply and said common connector region is connected to the power receiving device.

13. A fuse in accordance with claim 12 wherein said at least one fuse link is fabricated from copper.

14. A fuse in accordance with claim 12 wherein said overlay is fabricated from tin.

15. A fuse in accordance with claim 12 wherein at least one of said fuse links is skived.

16. A fuse in accordance with claim 12, each fuse link having an operating point, said operating point of at least one fuse link different from another of said fuse links.

17. A fuse in accordance with claim 12, further comprising a protective body attached to said fuse in at least the area of said fuse links.
